(19) United States
(12) Patent Application Publication
(10) Pub. No.: US 2002/0157496 A1
(43) Pub. Date: Oct. 31, 2002

(54) Accelerator pedal module

(76) Inventor: Dirk Meyer, Weinstadt (DE)

Correspondence Address: RONALD E. GREIGG, GREIGG & GREIGG P.L.L.C., 1423 POWHATAN STREET, UNIT ONE, ALEXANDRIA, VA, 22314, US

(21) Appl. No.: 10/030,633

(22) PCT Filed: May 8, 2001
(86) PCT No.: PCT/DE01/01722

(30) Foreign Application Priority Data
May 11, 2000 (DE) 100 22 960.3

(51) Int. Cl. G05G 1/14

(52) U.S. Cl. 74/512

(57) ABSTRACT

In a gas pedal not pivotably connected to the passenger compartment floor, there has been the problem until now that the pivoting motion of the gas pedal is not perceived as being as comfortable as when a gas pedal pivotably connected to the passenger compartment floor is actuated. In the drive pedal module (1) proposed here, it is attained that the pedal lever (10) together with the footrest surface (20) lends the same sensation to the driver's foot as if the pedal lever (10) were secured to the passenger compartment floor (26). The drive pedal module is intended for controlling the travel speed of a vehicle.

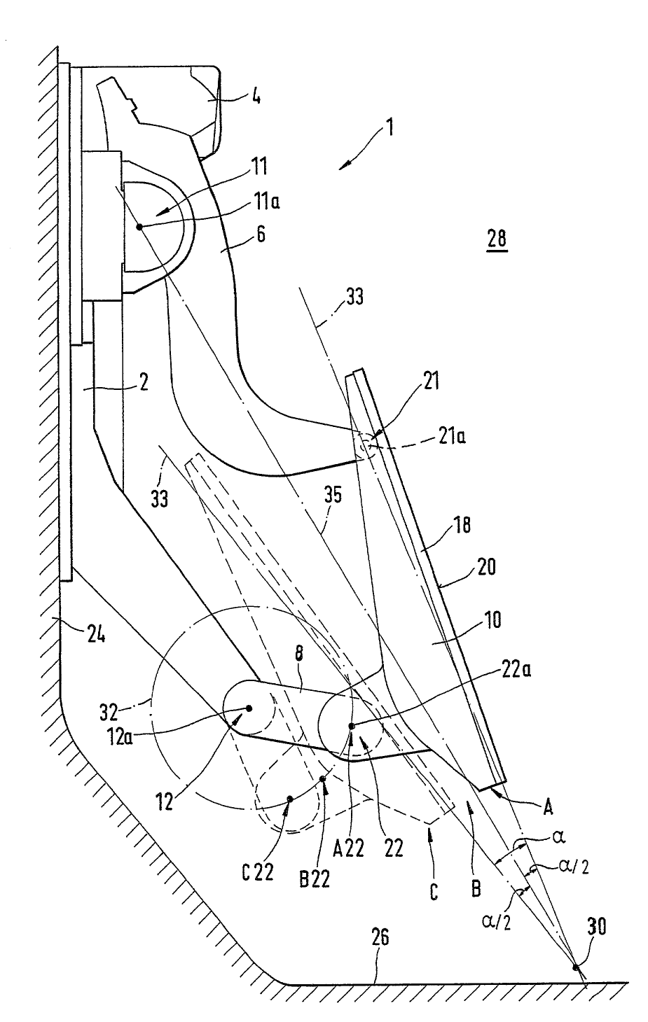

### PRIOR ART

The invention is based on an drive pedal module as generically defined by the preamble to claim 1.

U.S. Pat. No. 4,528,590 shows an drive pedal module that can be mounted on the passenger compartment floor of a motor vehicle. In this drive pedal module, the rotation point of the footrest surface of the pedal lever can be defined such that upon an actuation of the pedal lever, a comfortable sensation for the driver's foot results. However, many motor vehicle manufacturers do not want to mount the drive pedal module in the region of the passenger compartment floor; instead, they much prefer securing the drive pedal module to an upright wall of the passenger compartment or to carriers present in the region under the steering column. There are various reasons for this, in particular the goal of simpler, faster mounting of the drive pedal module, but also possible vibration in the region of the passenger compartment floor and because of the opinion that in an accident, there is less risk to the driver's foot if the drive pedal module is not secured to the passenger compartment floor.

Japanese Patent Disclosure JP 60-99729 (Serial Number 58-207192) shows an drive pedal module that can be mounted on an upright wall of a passenger compartment. However, in this drive pedal module there is the disadvantage that the rotation point of the pedal lever, with the footrest surface, is located far above and hence far away from the lower end of the driver's heel. Some drivers find this uncomfortable and irritating upon actuation of the pedal lever.

European Patent Disclosure EP 0 575 197 A1 and U.S. Pat. Nos. 5,321,980 and 5,133,321 show drive pedal modules in which the rotation point of the pedal lever with the footrest surface is located in the region of the lower end of the driver's heel. However, producing these drive pedal modules is quite complicated and expensive, and the point where these drive pedal modules have to be mounted is not accepted by many motor vehicle manufacturers.

U.S. Pat. Nos. 5,063,811 and Published International Patent Application WO 89/07706 show pedal arrangements in which the rotation point of the pedal lever with the footrest surface is located in the region of the passenger compartment floor, and the sensors for ascertaining the position of the pedal lever are located on an upright wall of the passenger compartment, above the passenger compartment floor. Although upon actuation of the pedal lever in these pedal arrangements the sensation for the driver's foot is comfortable, nevertheless these pedal arrangements are all quite large in size, and the effort and expense for producing and installing these pedal arrangements in motor vehicles is quite high.

German Published, Nonexamined Patent Disclosure DE 195 00 569 A1 shows an drive pedal module that can be mounted on an upright wall of the passenger compartment and has a link spring. With the aid of the link spring, a course of motion is to be attained that is approximately equivalent to that of a pedal mounted on the passenger compartment floor, but this is not successfully achieved. in addition, this arrangement is fairly large in size; furthermore, it is vulnerable to breakage, and the free space between the lower edge of the link spring and the passenger compartment floor is reduced in size.

German Published, Nonexamined Patent Application DE 197 01 184 A1 shows an drive pedal module that can be mounted on an upright wall of the passenger compartment. Upon actuation of the pedal lever with the footrest surface, the pedal lever moves downward approximately parallel to the upright wall of the passenger compartment. It is true that in some work machines, as in forklifts, in which the driver's typical seating position is elevated, the course of motion of the pedal lever of this drive pedal module may not be perceived as especially irritating. In motor vehicles, such as passenger cars however, where a much lower seating position is usual, such a course of motion of the pedal lever would be unacceptable.

### ADVANTAGES OF THE INVENTION

The drive pedal module, embodied according to the invention and defined by the characteristics of the body of claim 1, has the advantage over the prior art that despite being mounted above the passenger compartment floor, the drive pedal module lends the driver's foot that actuates the pedal lever a sensation that is similarly comfortable to that of a pedal arrangement with a pedal lever in which the rotation point is located physically in the immediate vicinity of the passenger compartment floor. Upon actuation, the drive pedal module of the invention offers a level of comfort that is at least equal to that of a pedal lever mounted on the passenger compartment floor.

Another advantage of this drive pedal module is that the overall drive pedal module is easy to make and relatively small in size, can be preassembled in compact form, and can be secured, without requiring additional work, to an upright wall of the passenger compartment or to some other carrier above the passenger compartment floor. Another advantage is the good resistance to vibration of the drive pedal module as well as its low vulnerability to breakage and wear. Still another advantage is that a fairly large and relatively constant intermediate space can be left open between the lower edge of the drive pedal module and the passenger compartment floor.

The method for structurally defining the pivot axis of the second lever pivot joint has the advantage that the pivot axis of the second lever pivot joint can be defined in a very simple way and quite precisely.

By means of the provisions recited in the dependent claims, advantageous refinements of and improvements to the drive pedal module defined by the main claim are possible.

In particular, the advantage is additionally obtained that the pivot point of the pd with the footrest surface can be defined even more substantially precisely, and that the pivot point is located precisely at the point where it is desired for the sake of achieving an especially comfortable sensation for the driver's foot that is actuating the pedal lever.

### DRAWING

One preferably selected, especially advantageous exemplary embodiment of the invention is shown in simplified form in the drawing and explained in further detail in the ensuing description.

### DESCRIPTION OF THE EXEMPLARY EMBODIMENT

The drive pedal module 1 embodied according to the invention can be used to control various driving machines. For example, the driving machine is an Otto engine, whose throttle valve is adjusted with a control motor. In that case, the drive pedal module 1 serves to output electrical signals, which are delivered to the control motor that adjusts the throttle valve. However, the driving machine can also be a Diesel engine, for example, or an electric motor; in these cases as well, electrical signals originate at the drive pedal module 1 and, suitably reshaped, control the output of the driving machine.

However, the drive pedal module 1 can also be used to actuate a brake or clutch of the motor vehicle.

The drive pedal module 1 is preferably secured directly to a vehicle part 24 of the motor vehicle, within the range of action of the vehicle driver. In those cases where the drive pedal module 1 is used to control the power of the driving machine, the pedal lever 10 of the drive pedal module 1 is often also called a gas pedal.

The drawing shows a preferably selected, especially advantageous exemplary embodiment. It shows a side view of the drive pedal module 1.

The drive pedal module 1 includes a retaining structure 2, a sensor 4, a first lever 6, a second lever 8, and a pedal lever 10. Because of the three-dimensional disposition, the first lever 6 can also be called the upper lever, and the second lever 8 can also be called the lower lever. The mechanical connection between the sensor 4 and the first lever 6 can be done in the manner described at length and shown in Published International Patent Disclosure WO 97/12781 and in U.S. Pat. No. 5,934,152.

The first lever 6 is rotatably supported on the retaining structure 2 via a first lever pivot joint 11. The second lever 8 is rotatably supported on the retaining structure 2 via a second lever pivot joint 12. The pedal lever 10 is rotatably supported on the first lever 6 via a first pedal pivot joint 21, on the end of the first lever 6 remote from the first lever pivot joint 11. In addition, the pedal lever 10, on the end of the second lever 8 remote from the second lever pivot joint 12, is rotatably supported on the second lever 8 via a second pedal pivot joint 22.

A pedal plate 18 is provided on the side of the pedal lever 10 remote from the retaining structure 2. The pedal plate 18 has a footrest surface 20 pointing in the direction of the passenger compartment 28.

Depending on the position of the first lever 6, the sensor 4 furnishes electrical signals to a control unit, not shown, with which the power of the driving machine, not shown, can be varied. Since the motion of the first lever 6 is coupled with the motion of the pedal lever 10, the first lever 6 can be adjusted by way of depressing the footrest surface 20, and as a result, the driver's demand can be transmitted to the driving machine via the sensor 4.

The drive pedal module 1 can also be used such that with the aid of the sensor 4, a braking system, not shown, or clutch, not shown, of the motor vehicle is controlled. Another alternative is that the drive pedal module 1 can be modified such that, depending on the position of the first lever 6, hydraulic signals or mechanical signals are generated, for instance for actuating the brake or clutch of the motor vehicle.

Via fastening screws, not shown, the retaining structure 2 of the drive pedal module 1 is secured to a vehicle part 24. A passenger compartment floor 26 defines the passenger compartment 28 of the motor vehicle at the bottom. The vehicle part 24 is by way of example an upright wall and defines the front of the passenger compartment 28. The vehicle part 24 is for example a partition between the passenger compartment 28 and a space, such as an engine compartment, located ahead of the passenger compartment 28. The vehicle part 24 can, however, also for instance be a crossbeam or longitudinal beam provided under the steering column. The vehicle part 24, especially the partition, can be vertical or inclined. As the exemplary embodiment illustrated shows, the upward-protruding vehicle part 24 can merge integrally with the more-horizontal passenger compartment floor 26. As can also be seen easily from the drawing, the retaining structure 2 of the drive pedal module 1 is secured to the vehicle part 24 with pronounced spacing above the passenger compartment floor 26. In the exemplary embodiment shown, there is no direct contact between the drive pedal module 1 and the passenger compartment floor 26 of the motor vehicle.

The first lever pivot joint 11 has a pivot axis 11a, about which the first lever 6 is rotatable by a certain angle. The pivot axis 11a, extending perpendicular to the plane of the drawing, is represented symbolically in the drawing as a dot. The second lever pivot joint 12 has a pivot axis 12a, about which the second lever 8 is rotatable by a certain angle. The pivot axis 12a of the second lever pivot joint 12, extending perpendicular to the plane of the drawing, is represented symbolically in the drawing as a dot. The first pedal pivot joint 21 has a pivot axis, extending perpendicular to the plane of the drawing, about which the first lever 6 and the pedal lever 10 are rotatable relative to one another about a limited angle. The pivot axis, shown symbolically in the drawing as a dot, of the first pedal pivot joint 21 will hereinafter be called the rotation point 21a of the first pedal pivot joint 21. The second pedal pivot joint 22 has a pivot axis, about which the second lever 8 and the pedal lever 10 are rotatable relative to one another by a limited angle. The pivot axis, shown symbolically in the drawing as a dot, of the second pedal pivot joint 22 will hereinafter be called the rotation point 22a of the second pedal pivot joint 22.

By experimentation, a pivot point 30 can be ascertained. The pivot point 30 is the point that designates the place which is ascertained such that, when the pedal lever 10 with the footrest surface 20 provided on the pedal lever 10 rotates about this point, the most-comfortable, least fatiguing and least cramped sensation for the driver's foot actuating the pedal lever 10 is obtained. By experience, the best location for the pivot point 30 is in the region of the passenger compartment floor 26, but it can also be provided some distance away from the passenger compartment floor 26.

Depending on the seating position of the driver who is actuating the pedal lever 10, the pivot point 30 is ideally located directly on the surface of the passenger compartment floor 26, or the pivot point 30 is located somewhat above the passenger compartment floor 26, or the pivot point 30 is located slightly below the surface of the passenger compartment floor 26. The precise position of the pivot point 30 is dependent on the seating position that the motor vehicle offers and by the drivers that use the motor vehicle and can be defined by experiments as a mean value. The proposed drive pedal module 1 offers the advantageous possibility of placing the pivot point 30 precisely where the user of the drive pedal module 1 wishes it to be.

Since the ideal pivot point 30 is located in the region of the passenger compartment floor 26, or in the vicinity of the passenger compartment floor 26, and since the drive pedal module 1 and in particular the pedal lever 10 as well should have a minimum spacing from the passenger compartment floor 26, this minimum spacing being markedly greater than the spacing of the pivot point 30 from the passenger compartment floor 26, the result is that the pivot point 30 is located outside the pedal lever 10.

Although the pivot point 30 is located at a marked spacing outside of the pedal lever 10 of the drive pedal module 1, in the drive pedal module 1 proposed here it is attained that upon an actuation of the pedal plate 18, the pedal lever 10 together with the pedal plate 18 moves about the pivot point 30.

To achieve this, the pivot axis 12a of the second lever pivot joint 12 must be located at a very specific point. Only when the pivot axis 12a is located at this point is it attained that upon an actuation of the pedal lever 10, the pedal lever moves about the pivot point 30. The explanations that follow illustrate one simple way of ascertaining the required position of the pivot axis 12a of the second lever pivot joint 12. Or in other words, with the method described below, the place at which for structural reasons the pivot axis 12a of the second lever pivot joint 12 must be located can be ascertained in a simple way:

First, the retaining structure 2 with the first lever pivot joint 11, with the first lever 6 supported on the first lever pivot joint 11, and with the pedal lever 10 supported on the lever 6 via the first pedal pivot joint 21, is secured to the upward-protruding vehicle part 24. This can for instance be done in an actual experimental vehicle, or on a test bench provided for the purpose, or on the drafting board, or on a computer using computer-aided design and drafting software. The position of the second lever pivot joint 12 with the pivot axis 12a is not yet defined. Nor is the second lever 8 present yet. However, the rotation point 22a of the second pedal pivot joint 22 is already provided at the correct place on the pedal lever 10.

After this preliminary work, the pedal lever 10 is placed in a first position A, in which the pedal lever 10 is aligned and inclined in the manner in which it should ideally be located in the vehicle. It is especially favorable if for this first position A, the position in which the pedal lever 10 should be located in the unactuated position is used. The unactuated position typically corresponds to the idling position of the driving machine. In this position A of the pedal lever 10, the position of the rotation point 22a of the second pedal pivot joint 22 is marked. To make the process easier to explain, this position of the rotation point 22a will be called the first position A22. Next, by pivoting of the first lever 6 about the pivot axis 11a, the first lever 6 is rotated far enough that it is approximately in a middle position. In this position of the first lever 6, the pedal lever 10 is then pivoted about the rotation point 21a far enough that the pedal lever 10 is in a position in which it has executed a pivoting motion about the pivot point 30. This new position of the pedal lever 10 will be called here the second position B. The alignment of the pedal lever 10 is very simple to achieve, since in this setting the second lever 8 is not present. In this position B of the pedal lever 10, a second position B22 of the rotation point 22a is then marked. After that, the first lever 6 is then pivoted onward about the pivot axis 11a, until the lever 6 is in a third position. It is proposed that as the third position, the position in which the first lever 6 is located when fully depressed should be chosen; this typically corresponds to the full-load position for maximum power of the driving machine. In this position of the first lever 6, the pedal lever 10 is then rotated so far about the rotation point 21a that the pedal lever 10 is aligned in such a way that once again the position of the pedal lever 10 is equivalent to pivoting about the pivot point 30. In this third position C of the pedal lever 10, a third position C22 of the rotation point 22a of the second pedal pivot joint 22 is marked.

After this preliminary work, three marked positions A22, B22, C22 are available for the rotation point 22a of the second pedal pivot joint 22. Next, a center point of the circle 32 that passes through these three marked points of the positions A22, B22, C22 is ascertained. For the sake of faster orientation, the circle 32 is shown in the drawing as a dot-dashed line. Since the circle 32 is exactly defined by three points, and since with these three points A22, B22, C22 the center point of the circle 32 passing through the three points A22, B22, C22 can be ascertained exactly and in a simple way, it is easily possible to ascertain the place precisely at which the pivot axis 12a of the second lever pivot joint 12 must be located, in order to provide that upon an actuation of the pedal lever 10, the pedal lever 10 will execute a motion that is equivalent to pivoting about the pivot point 30. The center point of the circle 32 provides the ideal place for the pivot axis 12a of the second lever pivot joint 12. It should also be noted briefly that the method by which the center point of a circle passing through three predetermined points is ascertained is typically taught in general-education schools at the middle level and can also be looked up in many basic textbooks familiar to mathematicians and engineers. There are also many computer programs that upon pressing a key immediately indicate the center point of the circle passing through three points.

With the method described in the above paragraphs, the requisite position for the pivot axis 12a of the second lever pivot joint 12 can be determined and defined exactly in a simple way. With conventional machine tools, it can be attained that in the drive pedal modules that have the dimensions ascertained in this way, the pedal lever 10 with the footrest surface 20 pivots about the pivot point 30 when the pedal plate 18 is depressed.

It should also be noted that depending on the requirements of the customer using the drive pedal module 1, the actual location of the pivot axis 12a of the lever pivot joint 12 can also deviate somewhat from the ideal position, because some customers also tolerate a slight migration of the pivot point 30 during an actuation of the pedal lever 10.

Ascertaining the three positions A22, B22, C22 of the rotation point 22a is made easier if one imagines a straight orientation line 33 that is solidly connected to the pedal lever 10; the straight orientation line 33 extends beyond the physical circumference of the pedal lever 10. For the sake of better orientation, the straight orientation line 33 is shown as a dot-dashed line in the drawing. For ascertaining the three positions A22, B22, C22, the straight orientation line 33 can either be provided physically, for instance in the form of a bar, or the straight orientation line 33 can be imagined, or it can be entered as an auxiliary line in computer-aided design. While the three positions A, B and C of the pedal lever 10 are being ascertained, care need then only be taken that the straight orientation line 33 extend through the pivot point 30 in all three positions A, B, C. It is especially expedient and produces an especially precise result if the straight orientation line 33 is placed such that it also intersects the rotation point 21 a of the first pedal pivot joint 21. It is furthermore proposed that care be taken that the footrest surface 20 on the pedal lever 10 extend approximately parallel to the straight orientation line 33. Depending on the seating position of the driver, however, it can be expedient for the footrest surface 20 to be inclined slightly relative to the straight orientation line 33, as is shown in the drawing.

In the drawing, the pedal lever 10 is shown in solid lines in its unactuated position of repose. The position of repose corresponds to the position A and is marked A in the drawing. In addition, the drawing shows the pedal lever 10 in dashed lines as well, in its fully actuated final position, which has already been designated above as position C. Between positions A and C, there is also the position B of the pedal lever 10. In the drawing, for the sake of greater simplicity, the pedal lever 10 is not also shown in position B; instead, position B of the pedal lever 10 is merely represented by an arrow marked B.

The drawing shows the straight orientation line 33 twice in dashed lines. The straight orientation line 33 is shown once when the pedal lever 10 is in the unactuated position A, and the straight orientation line 33 is shown again when the pedal lever 10 is in its fully actuated position C.

Between the straight orientation lines 33 shown twice in dot-dashed lines, there is an angle alpha (α). That is, the pedal lever 10 pivots about the pivot point 30 by the angle alpha (α).

In the drawing, a straight connecting line 35 represented by a dot-dashed line is also symbolically represented as an aid in orientation. The straight connecting line 35 intersects the pivot axis 11a of the first lever pivot joint 11 and intersects the pivot point 30. If the pedal lever 10 is actuated out of the position A shown in solid lines to the position C shown in dashed lines, then the pedal lever 10 pivots about the pivot point 30; in the process, the pedal lever 10 initially executes a slight radial motion in the direction toward the pivot point 30, and before reaching the position C, the pedal lever 10 moves back away from the pivot point 30 somewhat in the radial direction. This radial motion, relative to the pivot point, of the pedal lever 10 is only very slight, and in practice is not perceived upon actuation of the pedal lever 10 by the driver's foot. Because of the motion of the pedal lever 10 toward the pivot point 30 and away from the pivot point 30 in the radial direction, the point 30 in the present description is called the pivot point or pivot axis, rather than the rotation point or pivot axis.

Relative to the pivot point 30, an especially slight radially extending motion of the pedal lever 10 is then attained if the drive pedal module 1 is designed such that the straight connecting line 35 is located inside the pivot angle alpha (α). The overall least radially extending motion of the pedal lever 10 is obtained whenever the straight connecting line 35 coincides with the angle bisector of the pivot angle alpha (α).

In overall terms, the smallest structural part dimensions are obtained whenever the horizontal spacing between the pivot axis 11a of the lever pivot joint 11 and the lower region of the pedal lever 10 is divided by three, and the pivot axis 12a of the lever pivot joint 12 and the rotation point 22a of the pedal pivot joint 22 are each provided at approximately one-third of the way along the horizontal spacing.

1. An drive pedal module for controlling a travel speed of a motor vehicle, having a retaining structure (2), a first lever (6), a second lever (8), and a pedal lever (10), the first lever (6) being rotatably supported on the retaining structure (2) via a first lever pivot joint (11), the second lever (8) being rotatably supported on the retaining structure (2) via a second lever pivot joint (12), and the pedal lever (10) being supported on the first lever (6) via a first pedal pivot joint (21) and on the second lever (8) via a second pedal pivot joint (22), and the retaining structure (2) being secured to a vehicle part (24) of the motor vehicle, characterized in that at a desired point outside the pedal lever (10), a pivot point (30) is provided, and an at least conceivable straight orientation line (33) of the pedal lever (10) passes essentially through the pivot point (30) in every position of the pedal lever (10).

2. The drive pedal module of claim 1, characterized in that the motor vehicle has a passenger compartment (28) and a passenger compartment floor (26) that defines the passenger compartment (28) at the bottom, and the retaining structure (2) is mounted on the vehicle part (24) above the passenger compartment floor (26).

3. The drive pedal module of claim 2, characterized in that the pivot point (30) is provided in the region of the passenger compartment floor (26).

4. The drive pedal module of one of claims 1-3, characterized in that the pedal lever (10) has a footrest surface (20), and the straight orientation line (33) extends essentially parallel to the footrest surface (20).

5. The drive pedal module of one of claims 1-4, characterized in that the straight orientation line (33) extends through the first pedal pivot joint (21).

6. The drive pedal module of one of claims 1-3, characterized in that the pedal lever (10) is pivotable about the pivot point (30) by a pivot angle (α), and a straight connecting line (35) extending through the first lever pivot joint (11) and through the pivot point (30) essentially forms an angle bisector of the pivot angle (α).

7. A method for structurally defining a pivot axis (12a) of the second lever pivot joint (12) of an drive pedal module (1) of one of claims 1-6, characterized in that in a first position (A) of the pedal lever (10), a first position (A22) of a rotation point (22a) of the second pedal pivot joint (22) is ascertained; in a second position (B) of the pedal lever (10) a second position (B22) of the rotation point (22a) of the second pedal pivot joint (22) is ascertained, and in third position (C) of the pedal lever (10) a third position (C22) of the rotation point (22a) of the second pedal pivot joint (22) is ascertained, and their center point of a circle (32) extending through the three positions (A22, B22, C22) of the rotation point (22a) of the second pedal pivot joint (22) is used as the pivot axis (12a) of the second lever pivot joint (12).

8. The method of claim 7, characterized in that the first position (A) of the pedal lever (10) is the unactuated idling position (A) of the pedal lever (10); the second position (B) of the pedal lever (10) is the mean deflection of the pedal lever (10); and the third position (C) of the pedal lever (10) is the fully actuated full-load position (C) of the pedal lever (10).
